(19) United States
(12) Patent Application Publication
(10) Pub. No.: US 2007/0133661 A1
(43) Pub. Date: Jun. 14, 2007

(54) DMB receiver capable of reducing time required for changing channel

(75) Inventor: Jino Lee, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/582,587

(22) Filed: Oct. 17, 2006

(30) Foreign Application Priority Data
Dec. 9, 2005 (KR) 10-2005-0120448

(51) Int. Cl. H04B 1/00; H04K 1/10; H04L 1/02

(52) U.S. Cl. 375/147; 375/260; 375/347

(57) ABSTRACT

Disclosed is a DMB (digital multimedia broadcasting) receiver configured such that PN (pseudo noise) code processing is performed prior to performing bit deinterleaving and Walsh code processing is performed after performing bit deinterleaving.

### BACKGROUND OF THE INVENTION

This application claims the priority of Korean Patent Application No. 2005-120448, filed on Dec. 9, 2005, in the Korean Intellectual Property Office, the disclosure of which is incorporated herein in its entirety by reference.

1. Field of the Invention

The present invention relates to digital multimedia broadcasting (DMB) that reduces the time required for changing a channel.

2. Description of Related Art

FIG. 1 is a DMB receiver according to the prior art.

A DMB receiver 100 generally includes a tuner 110, a CDM (code division multiplexing) demodulator 120, a channel decoder 130, and an image decoder 140.

The tuner 110 converts a DMB signal received over an antenna into a baseband signal.

The CDM demodulator 120 demodulates the baseband signal and extracts broadcast channel data and pilot channel data concerning a selected broadcast channel by referring to a Walsh code used to uniquely define individual communication channels.

The channel decoder 130 performs a forward error correction (FEC) process on the broadcast channel data and the pilot channel data extracted by the CDM demodulator 120.

The image decoder 140 performs an image decoding process on the broadcast channel data that is corrected by the channel decoder 130.

That is, a DMB transmitter performs Reed-Solomon coding, byte interleaving, viterbi coding, and bit interleaving processes on the broadcast data to generate a FEC-coded signal, multiplies the FEC-coded signal by a Walsh code and a pseudo noise (PN) code, and transmits the resultant signal to the DMB receiver 100. The DMB receiver 100 converts the DMB signal received over an antenna into a baseband signal by means of the tuner 110, demodulates the baseband signal by means of the CDM demodulator 120, and extracts broadcast channel data and pilot channel data concerning a selected broadcast channel by the use of the Walsh code used to uniquely define individual communication channels.

Next, the DMB receiver 100 performs a FEC process on the extracted broadcast channel data and pilot channel data by means of the channel decoder 130, performs an image decoding process on the error-corrected broadcast channel data by means of the image decoder 140, and displays an image on a display unit.

The broadcast channel data demodulated by the CDM demodulator 120 is multiplied by the PN code and the Walsh code, is integrated, and is transmitted to the channel decoder 130. Thus, a plurality of hardware, such as a bit deinterleaver, a viterbi decoder, a byte deinterleaver, and a Reed-Solomon decoder, is required in the channel decoder 130 to perform the FEC process on data concerning a pilot channel for a control signal, an EPG (electronic program guide) channel for providing broadcast program information, a CAS (conditional access system) channel, and a plurality of audio/video channels.

When a broadcast channel is selected, the data concerning the pilot channel, EPG channel, CAS channel, and audio/video channels are decoded through the bit deinterleaver, viterbi decoder, byte deinterleaver, and Reed-Solomon decoder in the channel decoder 130, respectively.

However, there is a problem in that, upon initial booting or changing a broadcast channel, it takes about 3-4 seconds in the bit deinterleaver, about 1-2 seconds in other parts of the channel decoder 130, and about 1-2 seconds in the image decoder 140. As a result, it takes a total of as much as 7-8 seconds to change a broadcast channel. For example, it takes about as much as 84 seconds to retrieve twelve channels.

### SUMMARY OF THE INVENTION

The present invention provides a DMB receiver that reduces the time required for changing a DMB channel by reducing the time required for a bit deinterleaving process.

According to an aspect of the present invention, there is provided a DMB (digital multimedia broadcasting) receiver configured such that PN (pseudo noise) code processing is performed prior to performing bit deinterleaving and Walsh code processing is performed after performing bit deinterleaving.

The DMB receiver may include: a tuner converting a DMB signal received over an antenna into a baseband signal; a CDM (code division multiplexing) demodulator demodulating the baseband signal and multiplying the demodulated baseband signal by a PN code that is independent of a channel; a channel decoder performing bit deinterleaving on the signal multiplied by the PN code by the CDM demodulator, multiplying the resultant signal by a Walsh code and integrating the signal to extract channel data concerning a selected broadcast channel, and performing FEC (forward error correction) process on the extracted channel data; and an image decoder performing image decoding on the broadcast channel data processed by the channel decoder.

The channel decoder may include: a bit deinterleaver performing bit deinterleaving on the signal multiplied by the PN code by the CDM demodulator; a multiplier multiplying the signal processed by the bit deinterleaver by the Walsh code; an integrator integrating the signal processed by the multiplier and extracting channel data concerning a selected broadcast channel; a viterbi decoder performing viterbi decoding on the broadcast channel data extracted by the integrator; a byte deinterleaver performing byte deinterleaving on the broadcast channel data processed by the viterbi decoder; and a Reed-Solomon decoder performing Reed-Solomon decoding on the broadcast channel data processed by the byte deinterleaver.

The bit deinterleaver may perform bit deinterleaving in units of eight bytes.

The bit deinterleaver may be implemented in software form.

### BRIEF DESCRIPTION OF THE DRAWINGS

The above and other features and advantages of the present invention will become more apparent by describing in detail exemplary embodiments thereof with reference to the attached drawings in which:

FIG. 1 is a DMB receiver according to the prior art; and

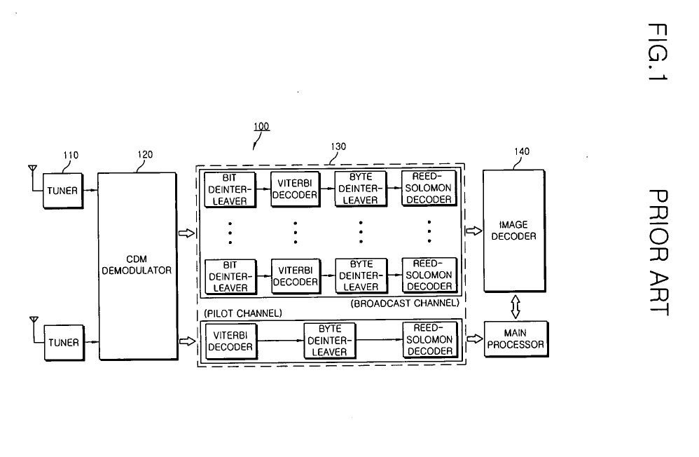

FIG. 2 is a block diagram of a DMB receiver according to an embodiment of the present invention.

### DETAILED DESCRIPTION OF THE INVENTION

Exemplary embodiments in accordance with the present invention will now be described in detail with reference to the accompanying drawings.

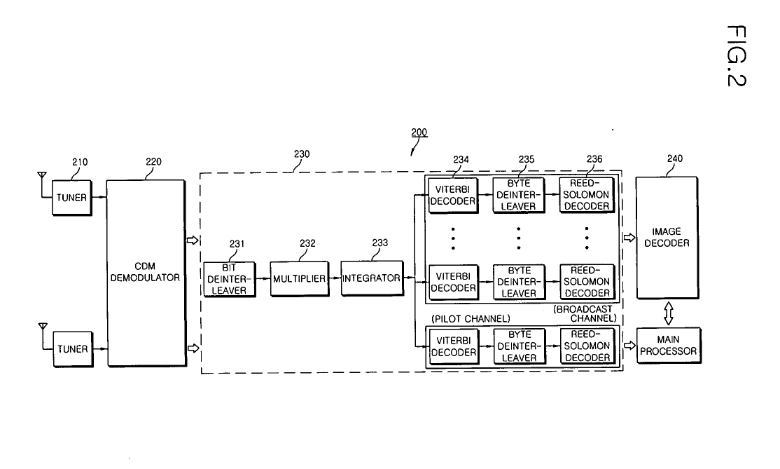

FIG. 2 is a block diagram of a digital multimedia broadcasting (DMB) receiver according to an embodiment of the present invention.

A DMB receiver is configured such that PN code processing is performed prior to performing bit deinterleaving and Walsh code processing is performed after performing bit deinterleaving. Thus, upon changing a broadcast channel, the Walsh code processing is required, while the PN code processing is no more required. As a result, the bit rate in bit deinterleaving processing is reduced, causing the time required for changing a DMB channel to be reduced.

In more detail, the DMB receiver 200 includes a tuner 210, a CDM demodulator 220, a channel decoder 230, and an image decoder 240.

The tuner 210 converts a DMB signal received over an antenna into a baseband signal.

A DMB transmitter performs Reed-Solomon coding, byte interleaving, viterbi coding, and bit interleaving on broadcast data to generate a FEC coded signal, multiplies the FEC coded signal by the Walsh code and the PN code to generate a spread modulated signal, and transmits the spread modulated signal.

The DMB receiver 200 receives the DMB signal over an antenna and converts the DMB signal into a baseband signal by means of the tuner 210.

The above-mentioned FEC coding and spread modulation technique is well known in the art and a detailed description thereof will thus be omitted herein.

The CDM demodulator 220 demodulates the baseband signal and multiplies the demodulated baseband signal by the PN code.

That is, when the DMB signal is converted to the baseband signal by means of the tuner 210, the DMB receiver 200 demodulates the baseband signal by means of the CDM demodulator 220.

Next, the DMB receiver 200 multiplies the demodulated signal by the PN code.

That is, while a DMB demodulator in a conventional DMB receiver performs both PN code processing and Walsh code processing, the DMB demodulator 220 according to the present invention performs only the PN code processing.

The channel decoder 230 performs bit deinterleaving on the signal multiplied by the PN code by the CDM demodulator 220, multiplies the signal by the Walsh code, integrates the resultant signal, extracts channel data concerning a selected broadcast channel, and performs FEC on the extracted channel data.

That is, when the signal demodulated by the CDM demodulator 220 is multiplied by the PN code, the DMB receiver 200 performs bit deinterleaving on the signal multiplied by the PN code by means of the channel decoder 230.

After performing the bit deinterleaving, a broadcast channel is selected by multiplying the signal by the Walsh code and integrating the resultant signal, and undergoes the FEC process.

Accordingly, the DMB receiver 200 is configured such that the PN code processing is performed in the CDM demodulator 220 prior to performing bit deinterleaving and the Walsh code processing is performed in the channel decoder 230 after performing bit deinterleaving. Thus, the bit rate in bit deinterleaving is reduced, causing the time required for changing the DMB channel to be reduced.

That is, the Walsh code processing is performed in the CDM demodulator in a conventional DMB receiver, while the Walsh code processing is performed in the channel decoder 230 in the present invention. Thus, the PN code processing and the Walsh code processing are performed before and after performing the bit deinterleaving.

The image decoder 240 performs image decoding on the broadcast channel data that has undergone the FEC process by means of the channel decoder 230.

After performing the FEC process on the broadcast channel data by means of the channel decoder 230, the DMB receiver 200 performs image decoding on the broadcast channel data by means of the image decoder 240 to display a broadcast image on a display unit (not shown) and to output voice to a speaker (not shown).

That is, since the DMB transmitter encodes video and audio data and transmits the encoded data to the DMB receiver, the channel decoder 230 decodes the encoded data.

A demultiplexer (not shown) may be further included between the channel decoder 230 and the image decoder 240 to demultiplex signals outputted from the channel decoder 230 and to output the demultiplexed signals to the image decoder 240.

The FEC decoding is performed in the reverse order of the FEC encoding. This is well known in the art and a detailed description thereof will thus be omitted herein.

Accordingly, the DMB receiver 200 is configured such that PN code processing is performed in the CDM demodulator 220 prior to performing bit deinterleaving and Walsh code processing is performed in the channel decoder 230 after performing bit deinterleaving. As a result, the bit rate in bit deinterleaving processing is reduced, causing the time required for changing a DMB channel to be reduced.

In more detail, the channel decoder 230 of the DMB receiver 200 includes a bit deinterleaver 231, a multiplier 232, an integrator 233, a viterbi decoder 234, a byte deinterleaver 235, and a Reed-Solomon decoder 236.

The bit deinterleaver 231 performs bit deinterleaving on the signal multiplied by the PN code by the CDM demodulator 220.

In the prior art, after data that has undergone the PN code processing and the Walsh code processing in the CDM demodulator prior to performing bit deinterleaving is input to the bit deinterleaver. Thus, data inputted to the bit deinterleaver needs to be retransmitted upon changing a channel and the bit rate of the data is high, causing the time required for changing the channel to be increased.

Further, in the prior art, a bit deinterleaver 231 having a plurality of hardware, such as shift register, as much as the number of channels identified by the Walsh code is required, causing the volume to be increased.

However, the bit deinterleaver 231 according to the present invention performs bit deinterleaving on a signal multiplied by the PN code by the CDM demodulator 220. Thus, data inputted to the bit deinterleaver 231 needs not to be retransmitted upon changing a channel, such that the time for changing the channel is not required.

The bit deinterleaver 231 performs bit deinterleaving on a signal multiplied by the PN code having sixty four bits (eight bytes). Thus, the bit deinterleaver 231 performs bit deinterleaving in units of eight bytes.

Accordingly, the bit deinterleaver 231 can be implemented in software form by allocating a buffer and performing bit deinterleaving to record data on the buffer.

The above-mentioned bit deinterleaving technique is well known in the art and a detailed description thereof will thus be omitted herein.

The multiplier 232 multiplies by the Walsh code the signal that has undergone the bit deinterleaving process by means of the bit deinterleaver 231.

The integrator 233 integrates the signal processed by the multiplier 232 and extracts channel data concerning a selected broadcast channel.

The DMB receiver 200 performs the PN code processing on a broadcast signal by means of the CDM demodulator 220, performs the Walsh code processing on the broadcast signal by means of the multiplier 232 of the channel decoder 230, integrates the signal processed by the multiplier 232 by means of the integrator 233, and extracts channel data concerning a selected broadcast channel.

The viterbi decoder 234 performs viterbi decoding on the broadcast channel data extracted by the integrator 230.

The byte deinterleaver 235 performs byte deinterleaving on the broadcast channel data decoded by the viterbi decoder 234.

The Reed-Solomon decoder 236 performs Reed-Solomon decoding on the broadcast channel data processed by the byte deinterleaver 235.

That is, the viterbi decoder 234, byte deinterleaver 235, and Reed-Solomon decoder 236 are formed in a plurality of hardware as much as the number of channels identified by the Walsh code and are the same as the viterbi decoder, byte deinterleaver, and Reed-Solomon decoder in the conventional channel decoder in terms of the structure and function. The viterbi decoder 234, byte deinterleaver 235, and Reed-Solomon decoder 236 are well known in the art and a detailed description thereof will thus be omitted herein.

Accordingly, the DMB receiver 200 multiplies a broadcast signal by the PN code in the CDM decoder 220, performs bit deinterleaving on the signal by means of the bit deinterleaver 231 of the channel decoder 230, multiplies the resultant signal by the Walsh code by means of the multiplier 232 of the channel decoder 230, obtains original broadcast signals by means of the integrator 233, and performs FEC process on data of a selected broadcast channel by means of the viterbi decoder 234, byte deinterleaver 235, and Reed-Solomon decoder 236.

As apparent from the above description, according to the present invention, the DMB receiver 200 is configured such that the PN code processing is performed in the CDM demodulator prior to performing bit deinterleaving and the Walsh code processing is performed in the channel decoder after performing bit deinterleaving. As a result, it is possible to reduce the bit rate in the bit deinterleaving upon changing the DMB channel, thus reducing the time required for changing the DMB channel.

While the present invention has been described with reference to exemplary embodiments thereof, it will be understood by those skilled in the art that various changes in form and details may be made therein without departing from the scope of the present invention as defined by the following claims.

What is claimed is:

1. A DMB (digital multimedia broadcasting) receiver is configured such that PN (pseudo noise) code processing is performed prior to performing bit deinterleaving and Walsh code processing is performed after performing bit deinterleaving.

2. The DMB receiver of claim 1, comprising:
a tuner converting a DMB signal received over an antenna into a baseband signal;
a CDM (code division multiplexing) demodulator demodulating the baseband signal and multiplying the demodulated baseband signal by a PN code that is independent of a channel;
a channel decoder performing bit deinterleaving on the signal multiplied by the PN code by the CDM demodulator, multiplying the resultant signal by a Walsh code and integrating the signal to extract channel data concerning a selected broadcast channel, and performing FEC (forward error correction) process on the extracted channel data; and
an image decoder performing image decoding on the broadcast channel data processed by the channel decoder.

3. The DMB receiver of claim 2, wherein the channel decoder comprises:
a bit deinterleaver performing bit deinterleaving on the signal multiplied by the PN code by the CDM demodulator;
a multiplier multiplying the signal processed by the bit deinterleaver by the Walsh code;
an integrator integrating the signal processed by the multiplier and extracting channel data concerning a selected broadcast channel;
a viterbi decoder performing viterbi decoding on the broadcast channel data extracted by the integrator;
a byte deinterleaver performing byte deinterleaving on the broadcast channel data processed by the viterbi decoder; and
a Reed-Solomon decoder performing Reed-Solomon decoding on the broadcast channel data processed by the byte deinterleaver.

4. The DMB receiver of claim 3, wherein the bit deinterleaver performs bit deinterleaving in units of eight bytes.

5. The DMB receiver of claim 4, wherein the bit deinterleaver is implemented in software form.
